(19) United States
(12) Patent Application Publication
(10) Pub. No.: US 2005/0266294 A1
(43) Pub. Date: Dec. 1, 2005

(54) Stack and fuel cell system having the same

(76) Inventors: Seong-Jin An, Suwon-si (KR); Hyoung-Juhn Kim, Suwon-si (KR); Yeong-Chan Eun, Suwon-si (KR); Sung-Yong Cho, Suwon-si (KR); Hae-Kwon Yoon, Suwon-si (KR); Jan-Dee Kim, Suwon-si (KR); Ho-Jin Kweon, Suwon-si (KR)

Correspondence Address: CHRISTIE, PARKER & HALE, LLP, PO BOX 7068, PASADENA, CA, 91109-7068, US

(21) Appl. No.: 11/133,696

(22) Filed: May 19, 2005

(30) Foreign Application Priority Data
May 25, 2004 (KR) 10-2004-0037270

(51) Int. Cl. H01M 8/00

(52) U.S. Cl. 429/34; 429/129; 429/247

(57) ABSTRACT

A fuel cell system includes a fuel supply unit for supplying fuel, an air supply unit for supplying air, and a stack for allowing hydrogen and oxygen supplied from the fuel supply unit and the air supply unit, respectively, to electrochemically react with each other and generating electrical energy. The stack has a membrane-electrode assembly and separators disposed at both sides of the membrane-electrode assembly. Each of the separators has a fuel passage and an air passage, and the total volume of the air passage is greater than the total volume of the fuel passage.

### CROSS REFERENCE TO RELATED APPLICATION

This application claims priority to and the benefit of Korean Patent Application No. 10-2004-0037270 filed on May 25, 2004 in the Korean Intellectual Property Office, the entire content of which is incorporated herein by reference.

### BACKGROUND OF THE INVENTION

1. Field of the Invention

The present invention relates to a fuel cell system that generates current using hydrogen and air and a stack used for the fuel cell system.

2. Background

In general, a fuel cell is an electricity generating system that directly converts the chemical reaction energy of hydrogen and oxygen, contained in hydrocarbon materials such as methanol, natural gas, etc., into electrical energy. Such a fuel cell can generate electricity while generating heat and water as byproducts. The electricity and heat can be used simultaneously through electrochemical reactions between hydrogen and oxygen without combustion.

A recently-developed polymer electrolyte membrane fuel cell (PEMFC) has an excellent output characteristic, a low operating temperature, and fast starting and response characteristics compared to other fuel cells. The PEMFC uses hydrogen obtained by reforming methanol, ethanol, natural gas, etc., as fuel. The PEMFC has a wide range of applications, including uses as a mobile power source for vehicles, a distributed power source for the home or buildings, and a small-sized power source for electronic apparatuses.

A PEMFC system includes a stack, a fuel tank, and a fuel pump. The stack makes up a main body of the fuel cell and the fuel pump supplies fuel of the fuel tank to the stack. The PEMFC system further includes a reformer that reforms the fuel to generate hydrogen gas and supplies the hydrogen gas to the stack in the course of supplying the fuel stored in the fuel tank to the stack.

The fuel stored in the fuel tank is supplied to the reformer by the fuel pump. Then, the reformer reforms the fuel and generates the hydrogen gas. The stack makes hydrogen and oxygen to electrochemically react with each other, thereby generating electrical energy.

A fuel cell can alternatively employ a direct oxidation fuel cell scheme, directly supplying liquid-state fuel containing hydrogen to the stack and generating current. The fuel cell employing the direct oxidation fuel cell scheme does not require a reformer.

In the fuel cell systems described above, the stack which is used to generate current has a stacked structure of several or several tens of unit cells. Each unit cell has a membrane-electrode assembly (MEA) and separators.

The MEA has an anode electrode attached to one surface of an electrolyte membrane and a cathode electrode attached to the other surface of the electrolyte membrane. The separator simultaneously performs a function as a fuel passage and an oxygen passage through which fuel required for the reaction of the fuel cell and oxygen are supplied and a function as a conductor connecting in series the anode electrode and the cathode electrode of the MEA to each other.

Through the separator, hydrogen is supplied to the anode electrode and oxygen is supplied to the cathode electrode. An oxidation reaction of hydrogen then takes place in the anode electrode and a reduction reaction of oxygen takes place in the cathode electrode. Due to movement of electrons generated at that time, electricity, heat, and water can be obtained from the stack.

The separator has a fuel passage for supplying hydrogen and an oxygen passage for supplying oxygen at both sides of the MEA. The total volume of the fuel passage is equal to the total volume of the oxygen passage. Therefore, the same amounts of hydrogen and oxygen can be supplied to generate current having an effective power density.

As described above, the same amounts of hydrogen and oxygen should be supplied so as to obtain effective current. However, in order to reduce cost, it is desirable to use air instead of expensive pure oxygen. The air typically contains about 21% oxygen.

Therefore, when it is intended to obtain the same effective current using air instead of pure oxygen, air should be supplied at a greater volume than pure oxygen.

### SUMMARY OF THE INVENTION

According to an embodiment of the present invention, a fuel cell system includes a fuel supply unit; an air supply unit; and a stack coupled to the fuel supply unit and the air supply unit. The stack includes a membrane-electrode assembly and separators disposed at opposite sides of the membrane-electrode assembly. Each of the separators has a fuel passage and an air passage. The air passage has a greater total volume than the fuel passage.

The fuel cell system may satisfy the following condition:
(Total volume of fuel passage)/(Total volume of air passage)= 1/7 to ⅓.

In one embodiment, each separator has a fuel passage formed on one surface and an air passage formed on an opposite surface. The fuel passage and the air passage may be formed by a first portion of the separator coming in close contact with the membrane-electrode assembly and a second portion of the separator being separated from the membrane-electrode assembly.

According to another embodiment of the present invention, a stack of a fuel cell system has a membrane-electrode assembly and separators disposed on both surfaces of the membrane-electrode assembly. In this embodiment, each separator has a fuel passage and an air passage formed by a contact portion coming in close contact with the membrane-electrode assembly and a separated portion separated from the membrane-electrode assembly. The total volume of the air passage is greater than the total volume of the fuel passage.

The fuel passage may be formed in a curved pattern on one surface of the separator and the air passage may be formed in a straight pattern on the other surface of the separator.

In another embodiment, a separator has an air passage on a first surface and a fuel passage on a second surface. The total volume of the air passage is greater than the total volume of the fuel passage. In one embodiment, the total volume of the air passage is three to seven times greater than the total volume of the fuel passage.

### BRIEF DESCRIPTION OF THE DRAWINGS

The above and other features and aspects of the present invention will become more apparent by describing in detail exemplary embodiments thereof with reference to the attached drawings in which:

FIG. 1 is a schematic diagram of a fuel cell system according to one embodiment of the present invention;

FIG. 2 is an exploded perspective view of a stack of the fuel cell system embodiment shown in FIG. 1;

FIG. 3A is a first side view of a separator in which air passages are formed according to an embodiment of the present invention;

FIG. 3B is an exploded view of the air passages on the separator embodiment shown in FIG. 3A;

FIG. 4A is a second side view of the separator of FIG. 3A, in which fuel passages are formed; and

FIG. 4B is an exploded view of the fuel passages on the separator embodiment shown in FIG. 4A.

### DETAILED DESCRIPTION OF THE EMBODIMENTS

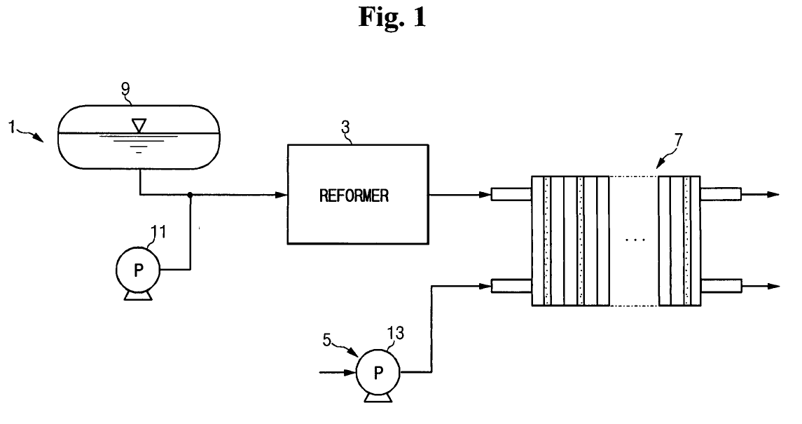

FIG. 1 shows a fuel cell system including a fuel supply unit 1 and a reformer 3 for supplying fuel, an air supply unit 5 for supplying air, and a stack 7 for allowing hydrogen and oxygen supplied from the fuel supply unit 1 and the air supply unit 5 to electrochemically react with each other to generate electrical energy.

The fuel supply unit 1 includes a fuel tank 9 and a fuel pump 11. The fuel tank 9 is connected to the stack 7 through the fuel pump 11. The fuel supply unit 1 supplies liquid fuel containing hydrogen such as methanol, ethanol, natural gas, etc. in the fuel tank 9 to the reformer 3 using the fuel pump 11, and supplies the hydrogen reformed by the reformer 3 into the stack 7.

The fuel cell system may alternatively employ a direct oxidation fuel cell scheme (not shown) which directly supplies the liquid fuel to the stack 7 and generates electricity, as is well-known in the art. Such a direct oxidation fuel cell system does not require the reformer 3, shown in FIG. 1. Although FIG. 1 shows an indirect oxidation fuel cell scheme, one skilled in the art will understand that both schemes are within the scope of the invention.

Referring again to FIG. 1, the air supply unit 5 has an air pump 13 and supplies air into the stack 7. The stack 7 is independently supplied with hydrogen and air through different passages. The stack 7 is supplied with hydrogen through the fuel supply unit 1 and the reformer 3, and is supplied with air from the air supply unit 5. The stack 7 allows the hydrogen and oxygen to electromechanically react with each other and generates electrical energy. In addition, the stack 7 generates heat and water as byproducts.

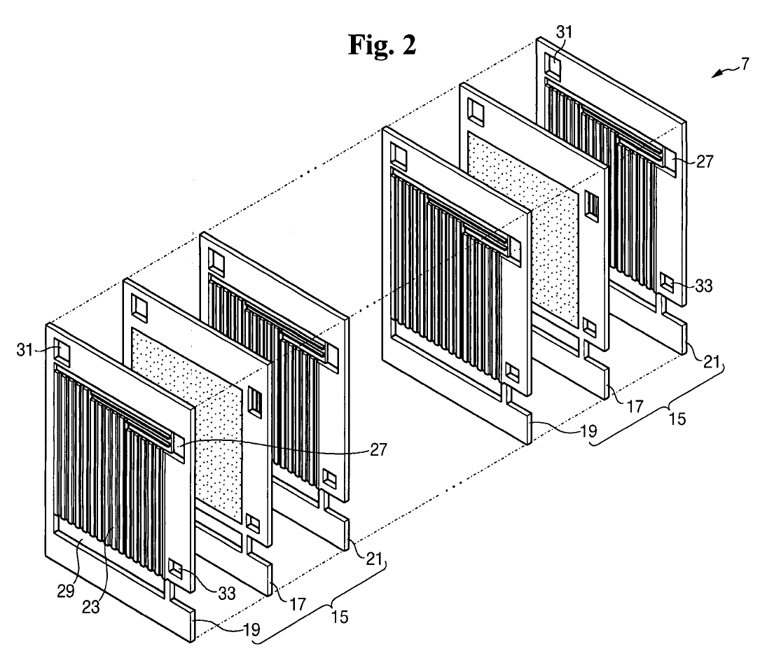

Referring to FIG. 2, the stack 7 includes a plurality of unit cells 15, each of which causes oxidation and reduction reactions between hydrogen, reformed by the reformer 3 (FIG. 1), and external air to generate electrical energy.

Each unit cell 15 is a unit for generating electricity, and includes a membrane-electrode assembly (MEA) 17 for causing the oxidation and reduction reactions between hydrogen and oxygen in the air. Separators 19 and 21 are disposed on both surfaces of the MEA 17 and supply hydrogen and air.

In the unit cell 15, the separators 19 and 21 are disposed on both sides of the MEA 17 to form a single stack. Multiple single stacks are stacked to form the stack 7. The unit cells 15 form the stack 7 having a stacked structure using known fastening members. One example of a known fastening member is a nut-and-bolt combination (not shown) or an equivalent, which may penetrate outer edges of the unit cells 15. Other examples of suitable fastening members are readily understood by those skilled in the art.

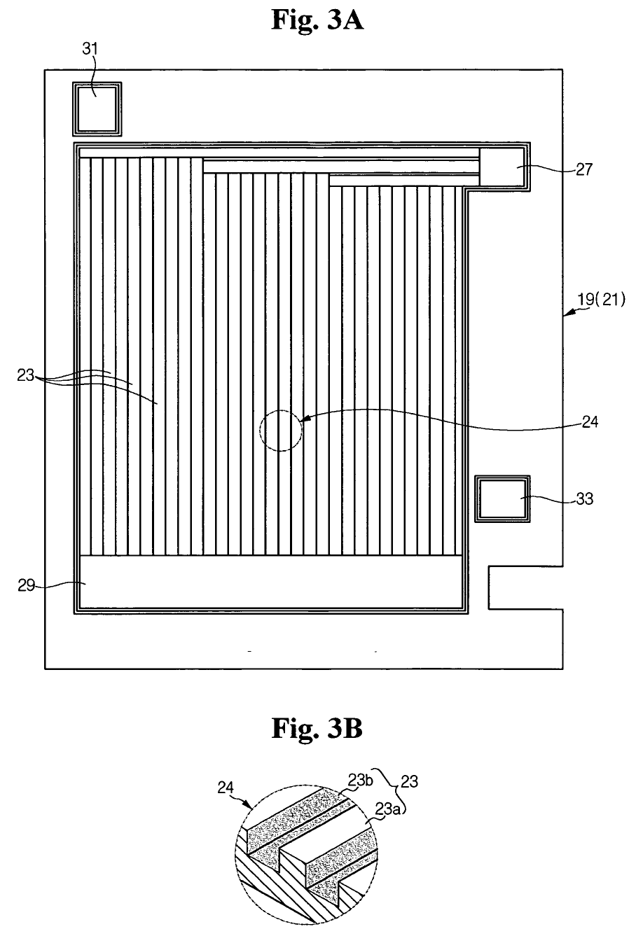

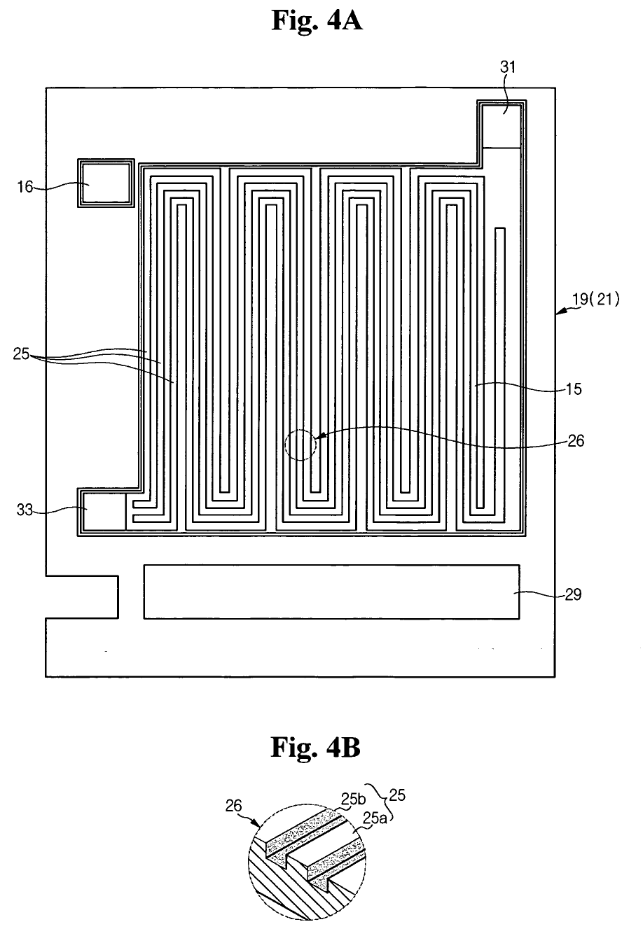

FIGS. 3A-3B illustrate one side of a separator, in which an air passage is formed according to one embodiment of the present invention, and FIGS. 4A-4B illustrate the other side of the separator, in which a fuel passage is formed.

Referring to FIGS. 1-4B, separators 19 and 21 are closely disposed on both surfaces of the MEA 17 to form air passages 23 and fuel passages 25 on either side of the MEA 17. The air passage 23 is connected to the air pump 13 and is supplied with air containing oxygen from the air pump 13. The fuel passage 25 is connected to the fuel tank 9 through the fuel pump 11 and is supplied with fuel containing hydrogen.

The air passage 23 has an air inlet 27 connected to the air pump 13 at one end thereof and an air outlet 29 for discharging non-reacted air at the other end thereof. Likewise, the fuel passage 25 has a fuel inlet 31 connected to the fuel pump 11 directly or through the reformer 3 at one end thereof and a fuel outlet 33 for discharging non-reacted fuel at the other end thereof.

The air passage 23 and the fuel passage 25 are formed by a portion of the separators 19 and 21 which comes in close contact with the MEA 17 and a portion of the separators 19 and 21 which is separated from the MEA 17. Areas 24 and 26 of FIGS. 3A and 4A are shown in exploded form in FIGS. 3B and 4B, in which the separator portions are shown in greater detail. The portions coming in close contact with the MEA 17 include ribs 23a and 25a that respectively protrude from the separators 19 and 21. The second portions that are separated from the MEA 17 include channels 23b and 25b, respectively, formed in a recessed shape in the separators 19 and 21. The air passage 23 and the fuel passage 25 are formed by combining the ribs 23a and 25a and the channels 23b and 25b, respectively, and have constant volumes.

The air passage 23 is disposed at the cathode electrode (not shown) side of the MEA 17 and the fuel passage 25 is disposed at the anode electrode side of the MEA 17.

As shown in FIGS. 3A-4B, the air passage 23 and the fuel passage 25 are formed by using an alternating arrangement of the channels 23b and 25b and the ribs 23a and 25a, which maintain a predetermined gap between the separators 19 and 21. The air passage 23 and the fuel passage 25 may also be formed in one passage, respectively, or may be formed such that a plurality of passages forms one group to reduce the supply pressure of air and fuel.

The air passage 23 and the fuel passage 25 may be formed in a curved pattern on the separators 19 and 21, a straight pattern, or any alternative pattern desired by one skilled in the art. In the embodiment shown in FIGS. 3A-4B, the air passage 23 is formed in a straight pattern and the fuel passage 25 is formed in a curved pattern. However, the present invention is not limited to the patterns shown.

In the embodiments shown, the air passage 23 and the fuel passage 25 are arranged in the same direction to be parallel to each other, but they may alternatively be arranged to intersect each other, if desired.

The air passage 23 is shown with a pattern in which channels are formed linearly in a vertical direction, are connected to one channel at the upside, and are connected to one channel at the downside. The fuel passage 25 has a curved pattern of a meandering shape. Accordingly, the air passage 23 as shown allows the air to flow in a direction (from the upside to the downside) and the fuel passage 25 allows the fuel to flow in alternating directions (from the upside to the downside and from the downside to the upside, as shown). The number passages and the direction of the air passage 23 and the fuel passage 25, however, are not limited to those described above, but may vary according to the needs of one skilled in the art.

Further, in the embodiments shown, oxygen passing through the air passage 23 is not pure oxygen but oxygen contained in air as described above. Accordingly, the air passage 23 has a total volume greater than that of the fuel passage 25 such that an amount of oxygen which can stably react with hydrogen passing through the fuel passage 25 is allowed to pass. The total volume of the air passage 23 and the total volume of the fuel passage 25 indicate the total volume of the respective channels arranged in active areas on the separators 19 and 21.

In one embodiment, the total volume of the fuel passage 25 and the total volume of the air passage 23 satisfy the following condition:
(Total volume of fuel passage)/(Total volume of air passage)= 1/7 to ⅓.

Therefore, the total volume of the air passage 23 ranges between 3 to 7 times the total volume of the fuel passage 25. When the total volume of the air passage 23 is less than 3 times the total volume of the fuel passage 25, the amount of oxygen contained in the supplied air may fail to cause the oxidation and reduction reactions with the fuel supplied through the fuel passage 25, thereby not generating current having an effective current density.

Further, when the total volume of the air passage 23 is greater than 7 times the total volume of the fuel passage 25, more oxygen than is required for the oxidation and reduction reactions is supplied, thereby consuming unnecessary energy for supplying the air.

A ratio of the total volume of the fuel passage 25 to the air passage 23 can be determined using a variety of methods, such as, for example, increasing the depth of the channels 23b of the air passage 23, while keeping their widths and lengths constant; increasing the length of the channels 23b, while keeping their width and depth constant, etc.

By forming the fuel passage 25, for supplying the hydrogen gas to the anode electrode of the MEA 17, and the air passage 23, for supplying the air to the cathode electrode, with the total volume ratio described above, it is possible to supply oxygen, that is, air, necessary for the oxidation and reduction reactions by a suitable or optimum amount.

In the fuel cell system and the stack thereof according to embodiments of the present invention described above, by making the volume of the air passage formed on one surface of the separator greater than the volume of the fuel passage formed on the other surface of the separator to supply the amount of air greater than the amount of fuel, the hydrogen gas as fuel and the air containing oxygen corresponding thereto can be supplied at the suitable or optimum ratio. Accordingly, even when supplying air, it is possible to generate current having the same effective power density as that of a case of supplying pure oxygen.

Although the exemplary embodiments of the present invention have been described, the present invention is not limited to the exemplary embodiments, but may be modified in various different ways without departing from the spirit or scope of the appended claims, the detailed description, and the accompanying drawings of the present invention. Thus, the present embodiments of the invention should be considered in all respects as illustrative and not restrictive, the scope of the invention to be determined by the appended claims and equivalents thereof.

1. A fuel cell system comprising:
a fuel supply unit;
an air supply unit; and
a stack coupled to the fuel supply unit and the air supply unit, the stack comprising:
a membrane-electrode assembly; and
separators disposed at opposite sides of the membrane-electrode assembly, each of the separators having a fuel passage and an air passage, the air passage having a greater total volume than the fuel passage.

2. The fuel cell system of claim 1, wherein the following condition is satisfied:
(Total volume of fuel passage)/(Total volume of air passage)= 1/7 to ⅓.

3. The fuel cell system of claim 1, wherein each separator has the fuel passage formed on one surface thereof and the air passage formed an opposite surface thereof.

4. The fuel cell system of claim 1, wherein the fuel passage and the air passage are formed by a first portion of the separator coming in close contact with the membrane-electrode assembly and a second portion of the separator being separated from the membrane-electrode assembly.

5. The fuel cell system of claim 1, wherein the fuel supply unit comprises a fuel tank and a fuel pump coupled between the fuel tank and the stack.

6. The fuel cell system of claim 1, wherein the air supply unit comprises an air pump adapted to supply air to the stack.

7. A stack of a fuel cell system, the stack comprising:
a membrane-electrode assembly having a first surface and a second surface;
a first separator having an air passage formed by a contact portion and a separated portion, the contact portion in close contact with the first surface of the membrane-electrode assembly, and the separated portion separated from the membrane-electrode assembly; and
a second separator having a fuel passage formed by a contact portion and a separated portion, the contact portion in close contact with the second surface of the membrane-electrode assembly, and the separated portion separated from the membrane-electrode assembly,
wherein a total volume of the air passage is greater than a total volume of the fuel passage.

8. The stack of a fuel cell system of claim 7, wherein the following condition is satisfied:
(Total volume of fuel passage)/(Total volume of air passage)= 1/7 to ⅓.

9. The stack of a fuel cell system of claim 7, wherein the first separator further comprises a second fuel passage disposed on a different surface than the air passage of the first separator, and wherein the second separator further comprises a second air passage disposed on a different surface than the fuel passage of the second separator.

10. The stack of a fuel cell system of claim 7, wherein the fuel passage is formed in a curved pattern and the air passage is formed in a straight pattern.

11. The stack of a fuel cell system of claim 9, wherein the fuel passage and the second fuel passage are formed in a curved pattern and the air passage and the second air passage are formed in a straight pattern.
